(19) United States
(12) Patent Application Publication
(10) Pub. No.: US 2017/0176672 A1
(43) Pub. Date: Jun. 22, 2017

(54) BEAM GUIDANCE SYSTEM AND METHOD FOR THE TRANSMISSION OF LASER LIGHT

(71) Applicant: PT Photonic Tools GmbH, Berlin (DE)

(72) Inventors: Ilya Kayander, Berlin (DE); Sebastian Eilzer, Berlin (DE); Max Funck, Potsdam (DE)

(21) Appl. No.: 15/387,002

(22) Filed: Dec. 21, 2016

(30) Foreign Application Priority Data
Dec. 22, 2015 (DE) 10 2015 122 551.4

(51) Int. Cl. G02B 6/032; G02B 6/024; G02B 6/27

(52) U.S. Cl. CPC G02B 6/032; G02B 6/2706; G02B 6/024

(57) ABSTRACT

A beam guidance system for the stable transmission of a polarization of laser light and a method for transmitting laser light are provided. The beam guidance system includes an optical fibre, a coupling device with an input and an output and a decoupling device for decoupling the laser light from the optical fibre.

### CROSS-REFERENCE TO RELATED APPLICATIONS

This application claims priority to German Patent Application DE 10 2015 122 551.4, filed on Dec. 22, 2015 and incorporated in its entirety by reference herein.

### BACKGROUND

Field

This application relates to a beam guidance system for the stable transmission of a polarization of laser light.

Description of the Related Art

It is known in the prior art that optical fibres can be used, amongst other uses, for the transport of laser light, when it comes to flexibly bridging distances between a component, which is to be processed by means of the laser light, and a laser beam source. In material processing with laser light, fibre-optic cables made of fibres are particularly advantageous. However, optical fibres are also used in applications of analytics, medical technology and microscopy. Step index fibres are established in industry for the transport of laser beams in continuous or quasi-continuous operation. Furthermore, fibres with a gradient profile in the refractive index profile and micro structured fibres with solid or gaseous core materials are known.

In particular, micro structured fibres with hollow cores are suitable for the transport of laser light with very short pulses as well as high pulse energies and pulse peak powers. In this way, through the light guidance in the hollow core, the interaction between laser light and fibre base material, which is typically quartz glass, can be minimized. This has a positive effect on the dispersion properties as well as on the destruction threshold of the fibre and also influences a series of nonlinear effects, which are described in connection with the transport of laser light through hollow core fibres. The transport of energy-rich laser pulses in the pico- and femtosecond range is only useful using hollow-core fibres. Typical hollow core fibres consist of a central hollow core, as well as a shell structure, which is arranged around the hollow core. This shell structure can in turn exhibit a micro structure that ensures that the light can be guided in the hollow core. Such fibres are well suited for the transport of laser light, but have the decisive disadvantage in many applications that maintaining of polarization is not possible. The maintenance of polarization direction and degree of polarization, however, are critical in many applications. In the processing of materials, the polarization influences, among other things, the absorption. Moreover, nonlinear processes are strongly dependent on the field intensity and thus also on the polarization of the laser light.

In hollow core fibres, the degree of polarization is randomly influenced so that, for example, energy portions pass from one direction of polarization into another or a depolarization occurs due to phase delays. Particularly in the case of dynamic applications, as are typical for the use of optical fibres, changes in the polarization orientation are caused by energy transfer between fibre modes. Particularly when the fibres are bent, a shift of the polarization components in both polarization directions can occur and thus a rotation of the polarization axis can occur. Especially for short- and ultra-short pulse beam sources, which have a high degree of polarization due to their design, it is desirable to maintain the polarization degree during the transport of laser light via a hollow-core fibre or to influence it in a targeted manner.

In order to influence the polarization behaviour, hollow-core fibres with several hollow cores are known. Alternatively, additional interference structures are described in the, prior art that serve to improve the degree of polarization (at the output). However, such a design is not suitable or desirable for all structures or fibre types. In addition, these interfering structures or the use of a plurality of hollow cores can lead to a complex construction of the light-conducting cable or a more complicated manufacture of the fibres, making the manufacturing and production process of the fibres and/or light-conducting cables more complicated and expensive. Furthermore, the transmission properties of the fibres can be impaired by the introduction of interference structures or the use of several hollow cores, because the principle of polarization maintenance in fibres is based on the reduction of undesired polarizations.

The possibilities known in the prior art for optimization of the polarization behaviour of laser light have the substantial disadvantage, that hollow-core fibres are generally not suitable for transporting linear polarized light in a controlled manner while maintaining the desired polarization direction and the degree of polarization, because, in particular upon movement of the fibre, for example in the case of bending, a change in the direction of polarization and in the degree of polarization can occur. Thus, for laser beam guidance in dynamic applications, constant polarization parameters for laser light cannot be guaranteed.

### SUMMARY

In certain aspects, a beam guidance system provides stable transmission of a polarization of laser light, wherein the beam guidance system comprises an optical fibre, a coupling device with an input and an output and a decoupling device for decoupling the laser light from the optical fibre. A further aspect of the invention relates to a method for transmitting laser light.

One objective of certain embodiments described herein is to provide a device and a method that do not have the deficiencies and disadvantages of the prior art, and enable a stabilization of the polarization transmission, in particular also during a movement and/or bending of the fibre optic fibre. Moreover, by means of certain embodiments described herein, a transmission of laser light with fixed polarization is to be achieved without major power fluctuations.

According to certain embodiments and in solution of the above objective, a beam guidance system is provided for the stable transmission of a polarization of laser light, wherein the beam guidance system comprises an optical fibre, a coupling device with an input and an output and a decoupling device for decoupling the laser light from the optical fibre, wherein the polarized light is coupled into an optical fibre by means of the coupling device, and wherein the polarization of the laser light is controlled at the input of the optical fibre and the optical fibre is a hollow core fibre. It was quite surprising that certain embodiments described herein can achieve a particularly high-performance polarization of the laser light.

For example, the polarization of the laser light may exist in a primarily linear polarization or in a primarily circular and/or elliptical polarization. For the purposes of certain embodiments, this polarization can be referred to as a defined or fixed polarization of laser light. For the purposes of certain embodiments, it is particularly preferred that essentially circular and/or elliptical polarized laser light is coupled into the optical fibre and is transported with this polarization through the optical fibre. It has been shown that during transport through the optical fibre the polarization of the essentially circular and/or elliptically polarized laser light is maintained astonishingly stably, in particular in cases of bending and/or movement of the optical fibre. It is preferable, that the laser light is decoupled from the optical fibre at the end of the optical fibre by means of the decoupling device. For the purposes of certain embodiments, it is preferred that a converter is positioned behind the decoupling device, which converts the essentially circularly and/or elliptically polarized laser light, which is transported through the optical fibre, into essentially linearly polarized laser light. It was completely surprising that, through the use of the beam guidance system according to certain embodiments, not only the polarization of the laser light is stably maintained, but also its performance. It has been shown that certain embodiments are particularly advantageous when the polarization of the laser light, which is emitted from a beam source, corresponds with the optical fibre.

After the coupling in of the laser light, which is preferably essentially circular and/or elliptically polarized, the light beam is transported with this polarization through the optical fibre, whereby changes in the degree of polarization and/or the polarization direction are surprisingly effectively avoided or reduced. This is especially true when the optical fibre is bent, when for example it has to be routed around corners or edges, in order to reach the location where the laser light is being used, or when the fibre is moved. With the beam guidance system according to certain embodiments, a system for transmitting laser light can thus be provided, surprisingly, in which the optical fibre can, in particular, also be bent or in motion, whereby advantageously, for example essentially linear polarized light is available at the beginning and at the end of the beam guidance system.

At the end of the optical fibre, the laser light which is, for example, essentially circular and/or elliptically polarized is preferably decoupled from the optical fibre. This can be done, for example, when the optical fibre ends because the location of use of the laser light is reached.

In certain embodiments it is preferable that the essentially circular and/or elliptical polarized laser light passes, after passing through the decoupling device, through the converter and is thereby converted into essentially linearly polarized laser light due to the different transmission speeds of the differently polarized light components. For the purposes of certain embodiments, it may also be preferable that a change in the direction of polarization is occurs in a light-conducting cable plug, in which a converter is provided. The converter is preferably positioned at the “end”, “rear” or in the “back end” of the beam guidance system, that is, behind the decoupling device and, for example, in the vicinity of the location of use of the laser light. As a result of the phase delay during the passage of the initially circular and/or elliptical polarized laser light through the converter, linearly polarized light can advantageously be produced at the fibre output which exhibits surprisingly a nearly constant polarization direction.

According to certain embodiments, it is further intended that the polarization of the laser light is monitored at the input of the optical fibre. It is preferable that this monitoring occurs between the coupling device and the optical fibre.

In certain embodiments, the beam guidance system comprises a beam source and a further converter for changing the polarization of the laser light, wherein the further converter is positioned between the beam source and the coupling device. The polarization of the laser light emitted by the beam source is preferably referred to as the first polarization in the sense of certain embodiments.

When this first polarization of the laser light, coming from the beam source, is in a linear polarization, the essentially linear polarized light is converted by the further converter into preferably circular and/or elliptical polarized laser light and as such is coupled into the optical fibre by means of the coupling device. This conversion or change of the laser light by the further converter is also preferably referred to as an adaptation of the polarization of the laser light to the optical fibre, whereby the average person skilled in the art knows which polarization directions and further characteristics of the laser light are particularly suitable for different types of optical fibres

In certain embodiments, the polarization of the laser light within the optical fibre is preferably referred to as the second polarization of the laser light. It preferably exhibits an elliptical and/or circular polarization with which the laser light is transported through the optical fibre. Preferably, a change in polarization occurs through the converter, which is positioned behind the decoupling device, in which the preferably second polarization, which preferably exhibits an elliptical and/or circular polarization of the laser light, is converted into a third polarization, which the laser light preferably exhibits after passing through the converter, which is positioned behind the decoupling device. This third polarization is preferably an essentially linear polarization of the laser light. A change in polarization of the laser light preferably takes place at the converter, which can preferably be such that the second and third polarizations of the laser light are preferably the same or different.

In other words, according to certain embodiments, a beam source emits essentially linearly polarized laser light, whereby a further converter is positioned between the beam source and the coupling device, wherein said converter converts the essentially linearly polarized laser light into essentially circular and/or elliptically polarized laser light. Preferably, the laser light, which emerges from the beam source as preferably linearly polarized light, is coupled into the optical fibre as circular and/or elliptically polarized laser light. This can preferably be achieved by performing a phase delay in one of the polarization directions by means of the further converter. In this case, the linearly polarized laser light is converted into circular and/or elliptically polarized light, for example by the use of a quarter-wave plate. In addition to the circular and/or elliptical polarization of the coupling, it is also preferable to introduce a converter as an element for polarization change at the decoupling end of the optical fibre, wherein the converter can preferably affect a phase delay in one polarization direction and polarizes the emerging essentially circular and/or elliptically polarized beam to an approximate linear polarization.

In certain embodiments, the beam guidance system for transmitting laser light comprises a beam source, which essentially emits laser light with a first polarization, a coupling device for coupling the laser light into an optical fibre, which has an input and an output, and a decoupling device for coupling out the laser light from the optical fibre, wherein a first converter for changing the polarization of the laser light from the first polarization to a second polarization is positioned between the beam source and the coupling device, and a second converter for modifying the polarization of the laser light emerging from the optical fibre from the second polarization to a third polarization is positioned behind the decoupling device, whereby the laser light is monitored at the input to the optical fibre. It is preferred that, in certain embodiments, the first converter corresponds to the previously described further converter, which is characterized with the reference feature 14 in FIG. 1, and the second converter corresponds to the previously described converter, which is identified by the reference feature 26 in FIG. 1.

For the purposes of certain embodiments, it is preferred that a beam source can consist of a single device, but it can also be preferred that a beam source is composed of several components. Laser light with a first polarization as a circularly polarized laser light can be generated, for example, by a beam source which is preferably composed of a resonator and a transducer. If a beam source that emits elliptically and/or circularly polarized light as a first polarization is used within the beam guidance system according to certain embodiments, the conversion of the polarization of this laser light by the first converter can advantageously be omitted, if it is to be transported with a second polarization as elliptical and/or circularly polarized light through the optical fibre.

Certain embodiments advantageously comprise both beam guidance systems with beam sources which emit linearly polarized light as first polarization, as well as beam sources which emit elliptically and/or circularly polarized light as a first polarization, whereby the beam sources preferably consist of a device or are composed of a plurality of devices.

In the context of certain embodiments, a beam guidance system is preferably an optical system for the transmission of light, in particular laser light. It may comprise various optical elements, such as filters, diaphragms, lenses, polarizers, collimators, and the like, which cooperate with the light passed through the beam guidance system. The beam guidance system according to certain embodiments is in particular suitable for the transmission of laser light from a beam source to a place or location of use, wherein a place or location of use in the sense of certain embodiments can be, for example, the location at which a workpiece is being processed with the laser light or a patient is treated with the laser light. Preferably, the beam source represents the beginning of the beam guidance system, which in the sense of certain embodiments is also referred to as “front”, “beginning” or “front end” of the beam guidance system.

In the context of certain embodiments, a beam source is preferably a light source, in particular for emitting laser light. It is particularly preferred in the context of certain embodiments that the laser light emitted by the beam source is essentially linearly polarized and has a high degree of linear polarization. However, it can also be preferable for other applications that the beam source emits circular and/or elliptically polarized laser light. The polarization of the laser light emitted by the beam source is preferably referred to in the sense of certain embodiments as a first polarization.

It is known that light or laser light can be described as an electromagnetic wave, whereby an electromagnetic wave comprises electric and magnetic fields that change periodically. It is preferred that the electric and magnetic fields of a wave train are preferably perpendicular to the propagation direction of the laser light. It is advantageously possible to produce such laser light, in which the electrical and the magnetic field behave in such a way to each other, that the fields vibrate parallel to one another. For the purposes of certain embodiments, such light is preferably referred to as linearly polarized light. The wording “essentially” is not unclear to the average person skilled in the art, since the average skilled person knows that the degree of polarization of the light emitted by a beam source is usually not 100%, but is generally less than 100%. In order to meet this deviation and also to ensure this deviation is encompassed by the description of certain embodiments, the laser light emitted by the beam source according to certain embodiments is preferably referred to as “essentially linearly polarized”. For the purposes of certain embodiments, the term “polarization degree” preferably means the ratio of the intensity of the polarized light component to the overall intensity of the light.

In certain embodiments, a first converter is arranged between the beam source and a coupling-in device. This first converter is preferably formed by a device which enables an adaptation of the polarization or the type of polarization of the laser light to the optical fibre. In particular, the first polarization of the laser light coming from the beam source is converted into a second polarization, whereby this conversion and/or change is preferably referred to as an adaptation of the polarization of the laser light to the optical fibre. In particular, the first polarization of the laser light coming from the beam source is converted into a second polarization, wherein this conversion and/or change is preferably referred to as an adaptation of the polarization of the laser light to the optical fibre. For example, essentially linearly polarized laser light, which is preferably emitted from the beam source of the beam guidance system, can be guided from the beam source to the first converter.

In certain embodiments, the first converter, which is arranged between the beam source and the coupling device, comprises a quarter-wave plate, with which the type of polarization of the laser light coming from the beam source can be changed, advantageously producing laser light with a second polarization. When coupling circular and/or elliptically polarized light into the optical fibre, the energy transfer, which occurs between light-guiding modes of the optical fibre with different polarization directions during movement of the optical fibre, is surprisingly efficiently suppressed, and thus the change in polarization is avoided.

The second converter, which is arranged behind the decoupling device, is preferably formed by a device which allows a change in the polarization or polarization type of the light emerging from the optical fibre. The optical effect of the two converters on the passing laser light is advantageously achieved by the beneficial embodiment of the converters, which is described by the following:

It is preferred that the first and/or the second converter of the beam guidance system according to certain embodiments comprise a quarter-wave plate, which is also referred to as a quarter-wave platelet, a delay plate, a wave plate, λ/4 plate or platelet. It is preferred that the quarter-wave plate is formed by one or more birefringent crystals, for example calcite, or a foil, whereby the selection and/or the thickness of the material influences the polarization behaviour of the plate or foil. Preferably, the two converters change the polarization and/or the phase of the incoming laser light and release this changed laser light again after passing through the converter so that it can be guided further through the beam guidance system according to certain embodiments.

It is preferred that a λ/4 plate phase delays the two portions of the laser light in its distinguished optical axes by one quarter wavelength, i.e., λ/4, wherein a quarter wave plate, for example, upon receiving linearly polarized light, can produce circularly and/or elliptically polarized light (for example: first converter), or can emit linearly polarized light (for example: second converter) from circularly and/or elliptically polarized light. For the purposes of certain embodiments, it is preferred that the polarization changes result from the fact that light can be decomposed into two perpendicular polarization directions. There is preferably a phase shift between the light components with polarization directions perpendicular to each other, since the light components pass through the quarter-wave plate at different speeds.

For the purposes of certain embodiments, the term circular polarized light, preferably such laser light, in which the electric field or the directional vector describing the electric field rotates about the propagation direction of the light. In particular, this is done with a constant angular velocity and without the field vector changing its value. Circular polarized light can, for example, result from the superimposition of two linearly polarized waves whose polarization direction is perpendicular to one another and which have a phase shift of 90°.

In the context of certain embodiments, light designated as elliptically polarized light, is light in which an arbitrary phase difference is present between two superimposed linearly polarized waves that are perpendicular to one another. It is preferred that, in the case of elliptically polarized light, the vector of the electric field rotates around the direction of propagation and also changes its value. Preferably, elliptically and/or circularly polarized light can be transported considerably better by optical fibres, in particular hollow core fibres, which is utilized in certain embodiments in order to obtain the essentially linearly polarized light generated by the beam source of the beam guidance system according to certain embodiments before coupling into the optical fibre into elliptical and/or circularly polarized light and as such is transported through the optical fibre. It was quite surprising that the change in the direction of polarization of the light can thereby be significantly reduced, such that certain embodiments therefore make a significant contribution to the polarization stabilization of the laser light in the beam guidance system. This is advantageously achieved without having to modify the optical fibre itself.

In certain embodiments, in which the beam source emits essentially linearly polarized laser light as a first polarization, the laser light located in the beam guidance system can be advantageously referred to as essentially circular and/or elliptically polarized light after passing through the first converter. This essentially circular and/or elliptically polarized light of the second polarization is then preferably coupled into the optical fibre by means of a coupling device, the optical fibre being a hollow-core fibre. Hollow core fibres are preferably characterized in that the optical fibre is not formed from a solid light-transmissive material but has a hollow core which is usually located centrally in the optical fibre and is filled with a gas, a gas mixture, for example air, also under changed pressure, whereby the type of filling preferably determines the optical properties of the fibre. It is known in this respect that there are Kagome patterns or anti-resonant fibres, which have a cavity arranged centrally in the fibre. For the purposes of certain embodiments, it may, for example, be preferable to fill the hollow core of a hollow core optical fibre with a gas with a low gas pressure. In addition, further cavities or capillaries can be provided in the optical fibre. Hollow-core bandgap crystal fibres utilize bandgap effects for the light transmission, while hollow-core fibres with Kagome patterns advantageously have a low density of cladding states, whereby light transmission is achieved over a broader spectral range with higher attenuation. Hollow core fibres usually have a multitude of thin walls or bars, which separate the individual hollow spaces or cavities, in particular the hollow core, from each other. Advantageously, hollow core fibres are particularly suitable for the transmission of light with high performance. In the context of certain embodiments, the coupling device is preferably characterised as such elements of an optical system which lead, bundle and/or influence an incoming light beam, here preferably a laser light beam, such that the light beam can be taken up by the optical fibre as an optical transport fibre.

Prefabricated fibre optic cables are to be distinguished from optical fibres, wherein the cables usually comprise, in addition to the optical fibre, for the transport of the laser light, prefabricated fibre ends in the form of plug connectors and cladding layers which surround the optical fibre as protection and/or dissipate heat and can comprise further optional components of the optical cable. In certain embodiments, at least one of the two converters of the beam guidance system, together with the optical fibre, forms a light-transmitting cable.

In certain embodiments, the converter and/or the further converter, or the first and second converter, comprise an electro-optical element. The electro optic element can, for example, be a Pockels cell in which a rotation is replaced by a voltage. It is preferred that the electro optic element be used for fast switching and/or modulating laser light in terms of phase, polarization and/or intensity.

In certain embodiments, the decoupling device comprises a collimator. For the purposes of certain embodiments, a collimator is preferably a device for generating an essentially parallel bundle of beams, by which the laser light is, for example, transported further after passage through the decoupling device of the beam guidance system according to certain embodiments. For example, the decoupling device and/or the collimator can comprise of at least one converging lens for the purposes of certain embodiments.

In certain embodiments, the laser light comprises short and/or ultrashort pulses with pulse durations in the range of nano to femto seconds. Laser light with short and/or ultrashort pulses with pulse durations in the nano to femtosecond range are characterized in particular by high pulse energies and pulse peak powers, which can be transported particularly well by hollow core fibres.

In certain embodiments, a converter for modifying the polarization of the laser light emerging from the optical fibre is positioned behind the decoupling device. Preferably, the laser light is decoupled from the optical fibre at the end of the optical fibre by means of the decoupling device. For the purposes of certain embodiments, it is preferred that a converter is arranged behind the decoupling device, which converts the essentially circularly and/or elliptically polarized laser light, which is preferably transported by the optical fibre, into essentially linearly polarized laser light. According to certain embodiments, the converter, which is positioned behind the decoupling device, is preferably considered as the second converter.

In certain embodiments, the polarization direction of at least one of the two convertors is configurable. In the context of certain embodiments, this preferably means that the polarization direction can be changed and thus configured in at least one of the two converters. Surprisingly, as a result, a particularly exact configuration of the stabilizing effect can be achieved.

In certain embodiments, the beam guidance system comprises a polarization beam splitter which is positioned behind the second converter. It is preferred that behind the second converter a polarization beam splitter, which is also referred to as a polarizer, is introduced into the beam trajectory in order to further considerably increase the degree of polarization of the laser light. This makes it possible to provide a beam guidance system which has excellent polarization with low power fluctuations due to movements and/or bends of the optical fibre. The use of the polarization beam splitter advantageously enables selection of the direction of polarization so that laser light with linear polarization and a high extinction ratio can be provided. For the purposes of certain embodiments, it is preferred to designate the degree of polarization of light as a synonym to the extinction ratio, whereby at the end of the beam guidance system according to certain embodiments laser light can be provided with a surprisingly high extinction ratio for use at the place of use.

The advantages achieved using certain embodiments, in particular, are that the change in the polarization orientation of the laser light can be significantly reduced. Surprisingly, a stabilization of the polarization transmission in hollow-core fibres is achieved without modifying the fibre itself. The fact that the polarization can also be transmitted stably in hollow core fibres, in particular when the fibre is bent or moved in the sense that it changes its shape, represents a departure from the state of the art, as thus far experts assumed that polarized light cannot be stably transported with respect to its polarization when passed through a hollow core fibre which has changed its shape. Thus, the beam guidance system according to certain embodiments in particular overcomes the technical preconception that the polarization of a beam changes between the beginning and the end of a moving fibre, in particular a hollow core fibre, and that the polarization between the input and the output of the fibre cannot be assumed preserved. However, this is surprisingly achieved by the design of the beam guidance system according to certain embodiments.

In a further aspect, certain embodiments relate to a method for transmitting laser light comprising the following steps:
a) Providing polarized laser light
b) Coupling the polarized laser light into an optical fibre by means of a coupling device
c) Transporting the laser light by means of the optical fibre
d) Decoupling the laser light from the optical fibre by means of a decoupling device
e) Changing the polarization of the laser light by a converter,

wherein the optical fibre is a hollow core fibre.

It is particularly preferred in certain embodiments if laser light is provided with an elliptical and/or circular polarization, coupled into the optical fibre and transported as elliptical and/or circular polarized laser light through the fibre, wherein the polarization of the polarized laser light can be converted by a converter, preferably into linearly polarized laser light.

For the purposes of certain embodiments, it is preferred that the method according to certain embodiments can be carried out with the beam guidance system according to certain embodiments. However, it may also be preferred for other applications to use an optical system with deviating components and properties for carrying out the method.

With regard to the terms used, reference is made to the statements on the beam guidance system according to certain embodiments.

In the method according to certain embodiments, the laser light, which is preferably provided as essentially circular and/or elliptically polarized, is coupled into an optical fibre by means of a coupling device. According to certain embodiments, it is intended that the optical fibre is formed by a hollow core fibre. It is further preferred if the laser light which is transmitted in the method according to certain embodiments comprises short and/or ultrashort pulses with pulse durations in the range from nano to femto seconds. In a next method step, the laser light, which is now essentially circularly and/or elliptically polarized, is transported through the optical fibre. It is preferred that the laser light is decoupled from the optical fibre at the end of the optical fibre by means of a decoupling device, wherein the decoupling device preferably comprises a collimator. It is particularly preferred in the context of certain embodiments if the decoupling unit and/or the collimator are formed by a converging lens.

After passage of the laser light through the decoupling unit, certain embodiments provide that the, for example, essentially circular and/or elliptical polarization of the laser light is converted by a converter into essentially linearly polarized light. For the purposes of certain embodiments, it is preferred if the converter is formed by a quarter-wave plate and is positioned behind the decoupling unit.

Certain embodiments relate to a method in which polarized laser light is generated by means of a beam source and the polarization of the laser light is variable by means of a further converter which is arranged between the beam source and the coupling device.

In a further aspect, certain embodiments relate to a method for transmitting laser light comprising the steps of:
a) Generation of laser light with a first polarization by means of a beam source
b) Changing the first polarization of the laser light by a first converter into a second polarization
c) Coupling the laser light into an optical fibre by means of a coupling device
d) Transporting the laser light by means of the optical fibre
e) Decoupling the laser light from the optical fibre by means of a decoupling device
f) Changing the second polarization of the laser light into a third polarization by a second converter.

In a first method step, laser light with a first polarization is generated and provided by means of a beam source. This can preferably be a linear polarization. In a second method step, the second polarization of the laser light generated by the beam source is changed during passage through a first converter into a second polarization which can preferably be an essentially circular and/or elliptical polarization. For the purposes of certain embodiments, this process step is also referred to as a conversion of the polarization direction or as an adaptation of the polarization of the laser light to the optical fibre. It is preferred in the sense of certain embodiments that the first converter is formed by a quarter-wave plate. The second converter of certain embodiments preferably corresponds to the previously described converter.

In certain embodiments, a polarization direction of the laser light is selected by means of a polarization beam splitter, which is positioned behind the second converter in the beam guidance system, whereby laser light can be provided with linear polarization and a surprisingly high extinction ratio.

### BRIEF DESCRIPTION OF THE DRAWINGS

Certain embodiments are described in more detail with reference to the following FIGURE:

FIG. 1 shows a schematic representation of certain embodiments of the beam guidance system.

### DETAILED DESCRIPTION

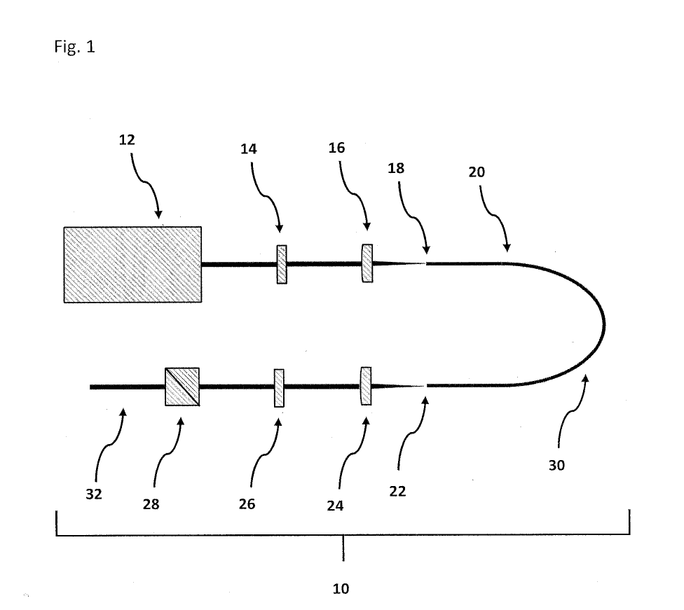

FIG. 1 shows a schematic representation of certain embodiments of the beam guidance system. A beam source (12) is shown, which emits, for example, linearly polarized laser light as a first polarization. For the purposes of certain embodiments, it is preferred that the laser light emitted by the beam source (12) has a high degree of polarization so that it is referred to as essentially polarized in the sense of certain embodiments. The preferably essentially linearly polarized laser light is guided to a first converter (14) within the beam guidance system (10), wherein the light, which essentially has a first polarization, is converted by the first converter (14) to for example circular and/or elliptically polarized light as a second polarization. For example, the first converter (14) and the second converter (26) can be formed by a quarter-wave plate. In particular, the polarization direction of the laser light changes from first polarization to second polarization by a phase delay which occurs at the first converter (14).

After passing through the first converter (14), the laser light is coupled into an optical fibre (20) by means of a coupling device (16) in the context of certain embodiments shown in FIG. 1. This coupling preferably takes place in the front section (18) of the optical fibre (20), where moreover a monitoring of the polarization of the laser light takes place. For the purposes of certain embodiments, it is preferred if the optical fibre (20) is formed by a hollow core fibre. The use of the second converter (26), and in certain embodiments, a further converter (14) for converting polarization modes of laser light to be transmitted through an optical fibre (20) has proven particularly effective when the optical fibre (20) is moved and/or has a bend (30). The laser light to be transmitted is, for example, linearly polarized laser light, which is usually not suitable for being transported by hollow-core fibres, because an undesirable and uncontrolled change occurs in the polarization direction and the degree of polarization, particularly when the optical fibre (20) is moving and/or being bent (30). This is particularly disadvantageous because no constant polarization parameters of the laser light can be guaranteed due to these undesirable changes in the properties of the laser light to being transmitted, for example when used in dynamic applications. Through the transport of the laser light as preferably elliptical and/or circularly polarized laser light through the optical fibre (20), an unexpectedly stable polarization of the laser light is achieved, wherein performance losses of the laser light are surprisingly effectively avoided and/or reduced.

At the end (22) of the optical fibre (20), the laser light with the second polarization is decoupled from the optical fibre (20) by means of a decoupling device (24). The second polarization of the laser light is then converted into a third polarization by a second converter (26). For example, laser light, which is transported as essentially circular and/or elliptically polarized laser light through the optical fibre (20), can be converted by the second converter into essentially linearly polarized light, wherein the essentially circular and/or elliptically polarized laser light is the second polarization and the essentially linearly polarized light corresponds to the third polarization. This can preferably take place at the place of use (32) of the laser light, at which the laser light is used, for example, for processing workpieces or for treating patients. Advantageously, polarization of the laser light is monitored at the input (18) of the optical fibre (20).

In certain embodiments, it may be preferred to provide a polarization beam splitter (28) behind the second converter (26) in the vicinity of the application site (32), which allows a selection of the polarization direction of the laser light, a high extinction ratio can be provided.

### REFERENCE LIST

10 Beam guidance system
12 Beam source
14 first or further converter
16 Coupling device
18 Beginning or input of the optical fibre
20 Optical fibre
22 End or output of the optical fibre
24 decoupling device
26 (second) converter
28 Polarization beam splitter
30 bend in the optical fibre
32 Place of use of the laser light

What is claimed is:

1. A beam guidance system for the stable transmission of a polarization of laser light, the beam guidance system comprising:
an optical fibre;
a coupling device with an input and an output; and
a decoupling device for decoupling the laser light from the optical fibre, wherein the polarized laser light is coupled into an optical fibre by means of the coupling device, the polarization of the laser light is controlled at the input of the optical fibre, and the optical fibre is a hollow core fibre.

2. A beam guidance system according to claim 1, wherein the beam guidance system further comprises a first converter for changing of the polarization of the laser light emerging from the optical fibre, the beam guidance system comprises a beam source and a second converter to change the polarization of the laser light, and the second converter is positioned between the beam source and the coupling device.

3. A beam guidance system according to claim 2, wherein the first converter and/or the second converter comprise a quarter wave plate.

4. A beam guidance system according to claim 2, wherein the first converter and/or the second converter comprise an electro-optical element.

5. A beam guidance system according to claim 1, wherein the laser light comprises short and/or ultra-short pulses with a pulse duration in the range of nanoseconds to femto seconds.

6. A beam guidance system according to claim 2, wherein the first converter for changing of the polarization of the laser light emerging from the optical fibre is positioned behind the decoupling device.

7. A beam guidance system according to claim 2, wherein a polarization direction of at least one of the first and second converters is adjustable.

8. A beam guidance system according to claim 1, wherein the decoupling device comprises a collimator.

9. A beam guidance system according to claim 2, wherein the beam guidance system comprises of a polarization beam splitter, which is positioned behind the first converter.

10. A beam guidance system according to claim 2, wherein at least one of the first and second converters, combined with the optical fibre, forms a optical fibre cable.

11. A method for the transmission of laser light comprising:
providing polarized laser light;
coupling the polarized laser light into an optical fibre using a coupling device;
transporting the laser light using an optical fibre;
decoupling the laser light from the optical fibre using a decoupling device; and
changing the polarization of the laser light through a converter, wherein the optical fibre is a hollow core fibre.

12. A method according to claim 11, wherein polarized laser light is generated using a beam source and the polarization of the laser light is adjustable using a second converter, which is positioned between the beam source and the coupling device.

13. A method according to claim 11, wherein a selection of a polarization direction of the laser light is effected using a polarization beam splitter, which is positioned behind the first converter.
